(19) United States
(12) Patent Application Publication
(10) Pub. No.: US 2012/0133137 A1
(43) Pub. Date: May 31, 2012

(54) WIND TURBINE SYSTEM COMPRISING A DOUBLY FED INDUCTION GENERATOR

(75) Inventors: Boyanapally Srilatha, Bangalore (IN); Munishwar Ahuja, Bangalore (IN); Kiruba Sivasubramaniam Haran, Clifton Park, NY (US); Sunil Srinivasa Murthy, Bangalore (IN)

(73) Assignee: GENERAL ELECTRIC COMPANY, SCHENECTADY, NY (US)

(21) Appl. No.: 13/325,107

(22) Filed: Dec. 14, 2011

(51) Int. Cl. F03D 9/00

(52) U.S. Cl. 290/44

(57) ABSTRACT

A wind turbine includes a gearbox coupled to a rotatable shaft for increasing speed of the rotation of the rotatable shaft, a doubly fed induction generator for generating electrical power from the rotations of the rotatable shaft comprising a stator and a rotor wherein the stator and the rotor comprise a plurality of stator slots and a plurality of rotor slots respectively and a tooth winding wound in at least one of the plurality of stator slots and the plurality of rotor slots wherein the tooth winding includes a fractional slot per pole per phase ratio, and a partial power converter electrically coupled to the doubly fed induction generator for controlling the electrical power for delivery to a power grid.

### BACKGROUND

The invention generally relates to wind turbine power generation systems and, more particularly, to doubly fed induction generators in wind turbine systems.

Renewable forms of energy, such as wind power, have become increasingly desirable sources for meeting present and future electrical power requirements. Wind power typically is harvested through the use of a wind turbine that includes a hub having multiple wind turbine blades mechanically coupled to a rotatable shaft. The rotatable shaft is connected to a drive train that typically includes a gearbox, a power generator, and a power converter.

The design of a wind turbine drive train is based on the operating speeds of the wind turbine in which the drive train will be installed. Such operating speeds are typically classified as high, medium and low. Low and medium operating speeds may be defined as speeds ranging from about 15 rotations per minute to about 600 rotations per minute. Some conventional low and medium speed wind turbine systems include a drivetrain comprising a gearbox, a permanent magnet generator, and a full power converter. The full power converter in such drivetrains is of a larger size and more expensive than desired. Another approach for fabricating the drivetrain is to use a partial converter with a doubly fed induction generator. However, doubly fed induction generators require a large number of stator and rotor slots to operate at low and medium speeds and generate electricity. The large number of slots in such embodiments increases the expense and weight such that these embodiments are often impractical for medium speed wind turbine systems.

Hence, there is a need for an improved system to address the aforementioned issues.

### BRIEF DESCRIPTION

In one embodiment, a wind turbine is provided. The wind turbine includes a tower, a nacelle supported by the tower, a hub attached to the nacelle, one or more rotor blades attached to the hub, a rotatable shaft coupled to the hub and configured to rotate based on the one or more rotor blades, a gearbox coupled to the rotatable shaft for increasing speed of the rotation of the rotatable shaft, a doubly fed induction generator for generating electrical power from the rotations of the rotatable shaft comprising a stator and a rotor wherein the stator and the rotor comprise a plurality of stator slots and a plurality of rotor slots respectively and a tooth winding wound in at least one of the plurality of stator slots and the plurality of rotor slots wherein the tooth winding comprises a fractional slot per pole per phase ratio, and a partial power converter electrically coupled to the doubly fed induction generator for controlling the electrical power for delivery to a power grid.

In another embodiment, a power conversion system is provided. The power conversion system includes a gearbox coupled to the rotatable shaft for increasing speed of rotation of the rotatable shaft, a doubly fed induction generator mounted on the gearbox for generating electrical power from the rotations of the rotatable shaft comprising a stator and a rotor wherein the stator and the rotor comprise a plurality of stator slots and a plurality of rotor slots respectively and a tooth winding wound in at least one of the plurality of stator slots and the plurality of rotor slots wherein the tooth winding includes a fractional slot per pole per phase ratio, and a partial power converter electrically coupled to the doubly fed induction generator for controlling a frequency of the electrical power for delivery to a power grid.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a wind turbine in accordance with an embodiment of the invention.

FIG. 2 is a schematic representation of a nacelle including gearbox, a doubly fed induction generator mounted on the gearbox, and a partial power converter in accordance with an embodiment of the invention.

FIG. 3 is a partial schematic representation of a stator and a rotor comprising a lap winding and a tooth winding respectively in a doubly fed induction generator in accordance with an embodiment of the invention.

FIG. 4 is a partial schematic representation of an alternative embodiment of a stator and a rotor comprising a tooth winding and a lap winding respectively in a doubly fed induction generator in accordance with an embodiment of the invention.

FIG. 5 is a partial schematic representation of another alternative embodiment of a stator and a rotor comprising a tooth winding in a doubly fed induction generator in accordance with an embodiment of the invention.

### DETAILED DESCRIPTION

Embodiments of the present invention include a wind turbine that includes a rotatable hub connected to a rotatable shaft that rotates based on one or more blades attached to the hub. The rotatable shaft is coupled to a gearbox that increases the speed of the rotations of the rotatable shaft. The rotatable shaft further rotates a doubly fed induction generator. The doubly fed induction generator includes a stator and a rotor that include a plurality of stator slots and a plurality of rotor slots respectively wherein at least one of the plurality of stator slots and the plurality of rotor slots include a tooth winding. The tooth winding in the doubly fed induction generator includes a fractional slot per pole per phase ratio. The doubly fed induction generator generates electricity from the rotations of the rotatable shaft. The wind turbine also includes a partial power converter electrically coupled to the doubly fed induction generator for controlling a frequency of the electrical power generated by the doubly fed induction generator that is fed to the power grid.

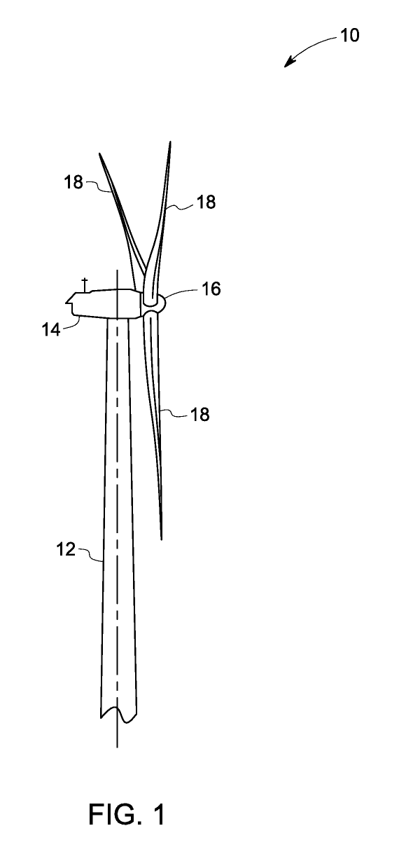

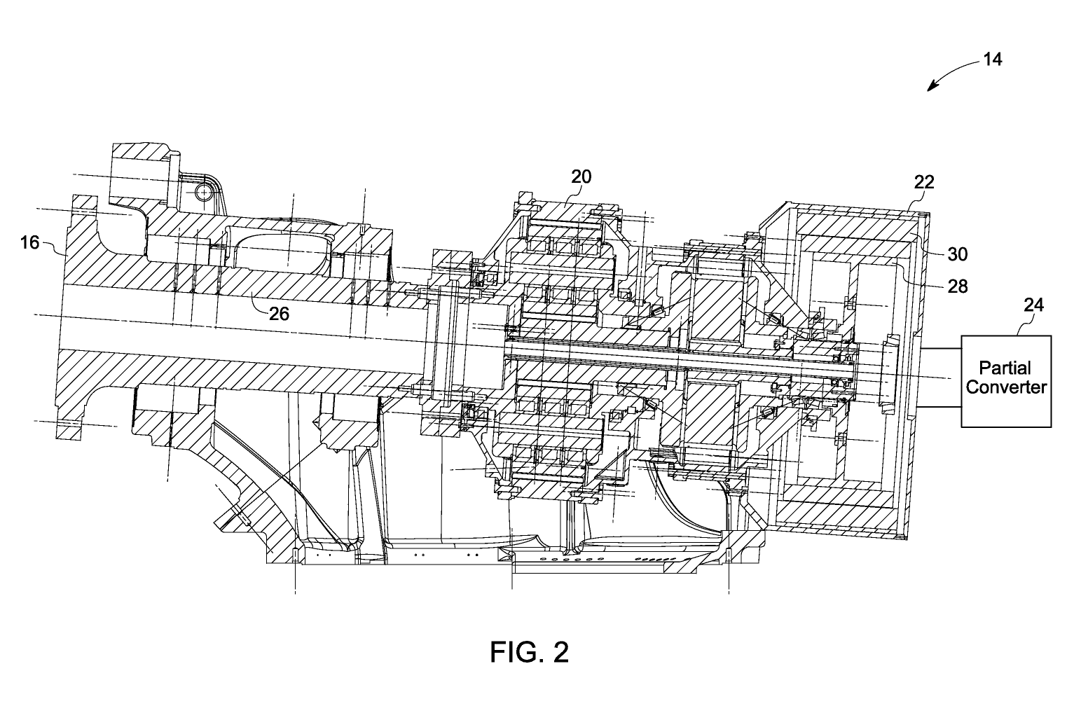

FIG. 1 is a schematic representation of a wind turbine 10 in accordance with an embodiment of the invention. The wind turbine 10 includes a tower 12 that supports a nacelle 14 at a desired height from the ground. The nacelle 14 is attached to a hub 16 that includes one or more rotor blades 18 attached to the hub 16. The nacelle 14 includes a rotatable shaft, a gearbox, a power generator and a power converter as described in FIG. 2 below that convert rotatable mechanical power to electrical power that is fed to a power grid (not shown).

FIG. 2 is a schematic representation of nacelle 14 housing a gearbox 20, a doubly fed induction generator 22 and a partial power converter 24 in accordance with an embodiment of the invention. The nacelle 14 includes a rotatable shaft 26 that is coupled to the hub 16. The rotatable shaft 26 is rotated by the one or more rotor blades 18 (FIG. 1) attached to the hub 16 and rotates based on the one or more rotor blades. The rotatable shaft 26 is coupled to the gearbox 20 that increases the speed of the rotations of the rotatable shaft 26. In one embodiment, the rotatable shaft 26 includes a two stage gearbox. The gearbox 20 includes two gears coupled to each other such that the gear box 20 increases the speed of the rotations to a range of about 15 rotations per minute to about 600 rotations per minute.

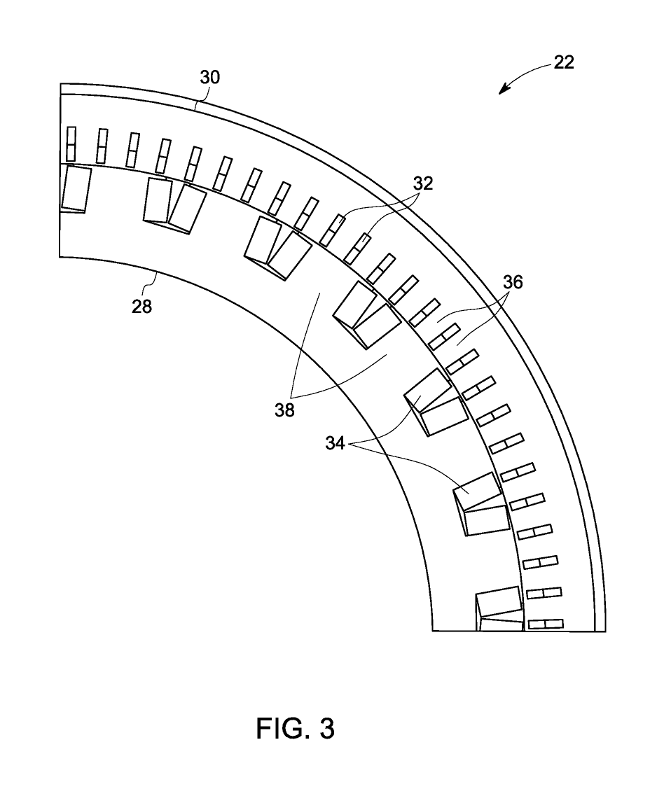

The rotatable shaft 26 is further coupled to the doubly fed induction generator 22 and rotates the doubly fed induction generator 22 to generate electricity from the rotations of the rotatable shaft 26. The doubly fed induction generator 22 comprises a rotor 28 and a stator 30 that includes a plurality of rotor slots (FIG. 3) and a plurality of stator slots (FIG. 3) respectively. In a specific embodiment, the doubly fed induction generator comprises a harmonically coupled doubly fed induction generator. The rotatable shaft 26 is coupled to the rotor 28 and rotates the rotor 28. The rotation generates a magnetic flux between the rotor 28 and the stator 30 that is converted to generate electricity.

The plurality of rotor slots and the plurality of stator slots are selected based on a required pole count, desired circumference, and desired size of the doubly fed induction generator 22. The pole count is determined by the equation: Srpm=120×f/N wherein Sᵣₚₘ is the speed of the rotatable shaft 26 in rounds per minute at the induction generator 22, f is the frequency of the grid, and N is the pole count. Based on this equation, for example, for a grid frequency of 60 hertz and speed of 300 rounds per minute, the pole count for the doubly fed induction generator 22 would be 24 poles. Subsequently, slots per pole (SPP) are selected for the doubly fed induction generator 22 based on the desired size and circumference of the doubly fed induction generator 22.

In conventional doubly fed induction generators, there is more than one slot per pole. Using more than one slot per pole serves to reduce undesired harmonics in the doubly fed induction generators. However, the selection of more than one slot per pole leads to a larger size of the doubly fed induction generator that makes the doubly fed induction generator impractical for use in a low and medium speed wind turbine system.

In one aspect of the present invention, in contrast to conventional approaches, the doubly fed induction generator 22 includes less than one slot per pole. In a more specific embodiment, for example, when the doubly fed induction generator 22 includes a tooth winding on the plurality of rotor slots and a lap winding on the plurality of stator slots, this embodiment enables the use of fractional slot per pole per phase ratio without inducing undesired harmonics in the doubly fed induction generator. The use of a fractional slot per pole per phase ratio in a doubly fed induction generator reduces the size of the doubly fed induction generator thus enables mounting of the doubly fed induction generator on the gearbox to provide a compact drivetrain. In one embodiment, the fractional slot per pole per phase ratio includes a half slot per pole per phase. In the half slot per pole phase embodiment, unlike other fractional ratio embodiments, the induction generator operates in a non-harmonically coupled mode.

The doubly fed induction generator 22 is coupled to a partial power converter 24 that controls a frequency of the electrical power generated from the doubly fed induction generator 22. In one embodiment, the partial power converter 24 includes a one third rated power converter. The partial power converter 24 controls the rotor 28 of the doubly fed induction generator 22 to provide a constant frequency electrical power to the power grid at variable speeds of the wind.

FIG. 3 is a partial schematic representation of the stator 30 and the rotor 28 comprising a lap winding 32 and a tooth winding 34 respectively in the doubly fed induction generator 22 in accordance with an embodiment of the invention. As shown, the stator 30 includes the plurality of stator slots 36 that include lap winding 32, and the rotor 28 includes the plurality of rotor slots 38 that include the tooth winding 34.

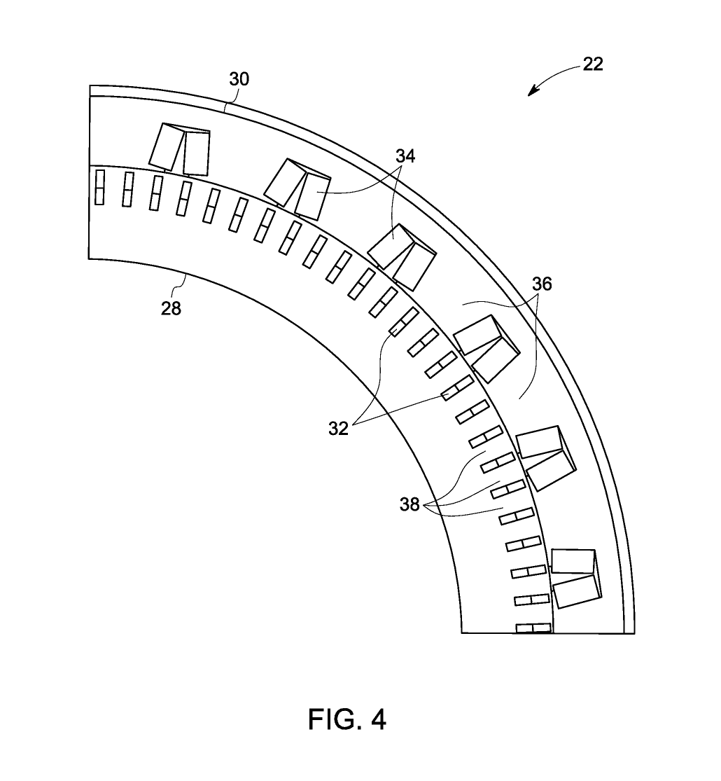

FIG. 4 is a partial schematic representation of an alternative embodiment of a stator 30 and a rotor 28 comprising a tooth winding 34 and a lap winding 32 respectively in the doubly fed induction generator 22 in accordance with an embodiment of the invention. In one embodiment, the plurality of stator slots 36 may include the tooth winding 34 and the plurality of rotor slots 38 may include the lap winding 32.

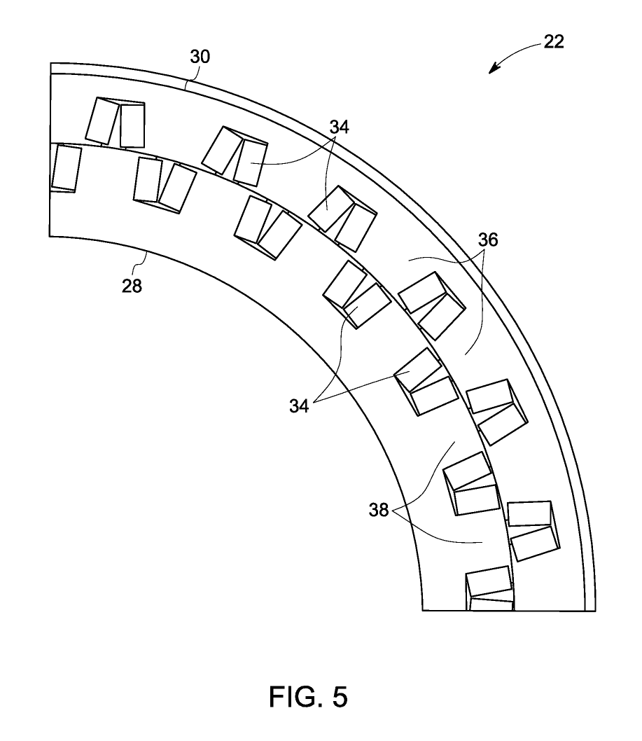

FIG. 5 is a partial schematic representation of another alternative embodiment of a stator 30 and a rotor 28 in the doubly fed induction generator 22 in accordance with an embodiment of the invention. In the embodiment of FIG. 5, the plurality of stator slots 36 and the plurality of rotor slots 38 both include tooth windings 34.

The various embodiments of the wind turbine described above are expected to provide a less expensive and smaller power conversion system.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this disclosure. It is, therefore, to be understood that the appended claims are intended to cover all such modifications and changes as fall within the true spirit of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A wind turbine comprising:
a tower;
a nacelle supported by the tower;
a hub attached to the nacelle;
one or more rotor blades attached to the hub;
a rotatable shaft coupled to the hub and configured to rotate based on the one or more rotor blades;
a gearbox coupled to the rotatable shaft for increasing speed of the rotation of the rotatable shaft;
a doubly fed induction generator for generating electrical power from the rotations of the rotatable shaft comprising a stator and a rotor wherein the stator and the rotor comprise a plurality of stator slots and a plurality of rotor slots respectively and a tooth winding wound in at least one of the plurality of stator slots and the plurality of rotor slots wherein the tooth winding comprises fractional slots per pole per phase ratio; and
a partial power converter electrically coupled to the doubly fed induction generator for controlling a frequency of the electrical power for delivery to a power grid.

2. The system of claim 1, wherein the gearbox comprises a two stage gearbox.

3. The system of claim 1, wherein the gearbox increases the speed of the rotations in the range of about 15 rotations per minute to about 600 rotations per minute.

4. The system of claim 1, wherein the doubly fed induction generator comprises a harmonically coupled doubly fed induction generator.

5. The system of claim 1, wherein the tooth winding is situated in the plurality of stator slots and further comprising a lap winding situated in the plurality of rotor slots.

6. The system of claim 1, wherein the tooth winding is situated in the plurality of rotor slots and further comprising a lap winding situated in the plurality of stator slots.

7. The system of claim 1, wherein the tooth winding comprises a first tooth winding situated in the plurality of stator slots and further comprising a second tooth winding situated in the plurality of rotor slots.

8. A power conversion system comprising:
a gearbox mechanically coupled to a rotatable shaft for increasing speed of rotation of the rotatable shaft;
a doubly fed induction generator mounted on the gearbox for generating electrical power from the rotations of the rotatable shaft comprising a stator and a rotor wherein the stator and the rotor comprise a plurality of stator slots and a plurality of rotor slots respectively, and a tooth winding wound in at least one of the plurality of stator slots and the plurality of rotor slots wherein the tooth winding comprises a fractional slot per pole per phase ratio; and
a partial power converter electrically coupled to the doubly fed induction generator for controlling a frequency of the electrical power for delivery to a power grid.

9. The power conversion system of claim 8, wherein the gearbox comprises a two stage gearbox.

10. The power conversion system of claim 8, wherein the gearbox increases the speed of rotations of the rotatable shaft in the range of about 15 rotations per minute to about 600 rotations per minute.

11. The power conversion system of claim 8, wherein the doubly fed induction generator comprises a harmonically coupled doubly fed induction generator.
